(19) United States
(12) Patent Application Publication
(10) Pub. No.: US 2006/0028685 A1
(43) Pub. Date: Feb. 9, 2006

(54) Method for allowing users to specify multiple quality settings on mixed printouts

(76) Inventors: Nicole Proulx, Austin, TX (US); Dustin Sorenson, Austin, TX (US)

Correspondence Address: HAMILTON & TERRILE, LLP, P.O. BOX 203518, AUSTIN, TX, 78720, US

(21) Appl. No.: 10/911,257

(22) Filed: Aug. 4, 2004

(51) Int. Cl. H04N 1/40; G06K 15/00

(52) U.S. Cl. 358/2.1

(57) ABSTRACT

A method for controlling the quality of a print job which includes selecting a first print quality for a first type of print object, selecting a second print quality for a second type of print object, and printing a print job such that the first type of print object is printed having the first print quality and the second type of print object is printed having the second print quality.

### BACKGROUND OF THE INVENTION

The present invention relates to printers and more particularly to controlling the output quality of printers.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

On known printer products, the user is often only allowed to set one quality setting per printout. If the printout has both graphics and text, the printer will apply the quality settings to both. So for example, if the user wants a “best” quality on the graphic, they also have to apply the “best” quality to the text which uses more ink. Some users may want to specify a “best” quality for the graphics and a “draft” quality for the text to conserve ink.

### SUMMARY OF THE INVENTION

In accordance with the present invention, a printer is provided with a print quality selection module which enables a user to select multiple quality settings for each printout. The user selects the quality settings via a print driver graphical user interface (GUI). Thus, within a single print job, a user can select a higher quality setting for the graphics and a lower quality setting for the text or vice versa. The printer quality selection module thus provides a user with greater control over the amount of ink used on mixed printouts.

The print quality selection module identifies the content of a print job, discriminating objects such as text and graphics, and then rasterizes the print job according to the discrete settings provided by the user to the print quality selection module. In one embodiment, the print quality module is included within a printer driver.

In one embodiment, the invention relates to a method for controlling the quality of a print job which includes selecting a first print quality for a first type of print object, selecting a second print quality for a second type of print object, and printing a print job such that the first type of print object is printed having the first print quality and the second type of print object is printed having the second print quality.

In another embodiment, the invention relates to an apparatus for controlling the quality of a print job which includes means for selecting a first print quality for a first type of print object, means for selecting a second print quality for a second type of print object, and means for printing a print job such that the first type of print object is printed having the first print quality and the second type of print object is printed having the second print quality.

In another embodiment the invention relates to an information handling system which includes an input output port and a control system coupled to the input output port. The control system includes a quality selection module. The quality selection module controls the quality of a job and includes a first selecting module, a second selection module and a presentation module. The selecting module selects a first print quality for a first type of object. The second selecting module selects a second print quality for a second type of object. The presentation module presents the job such that the first type of object is presented having the first presentation quality and the second type of object is presented having the second presentation quality.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an environment in which a printer is used.

FIG. 2 shows a flow chart showing the operation of the print quality selection module.

FIG. 3 shows an example of a print quality selection module graphical user interface.

### DETAILED DESCRIPTION

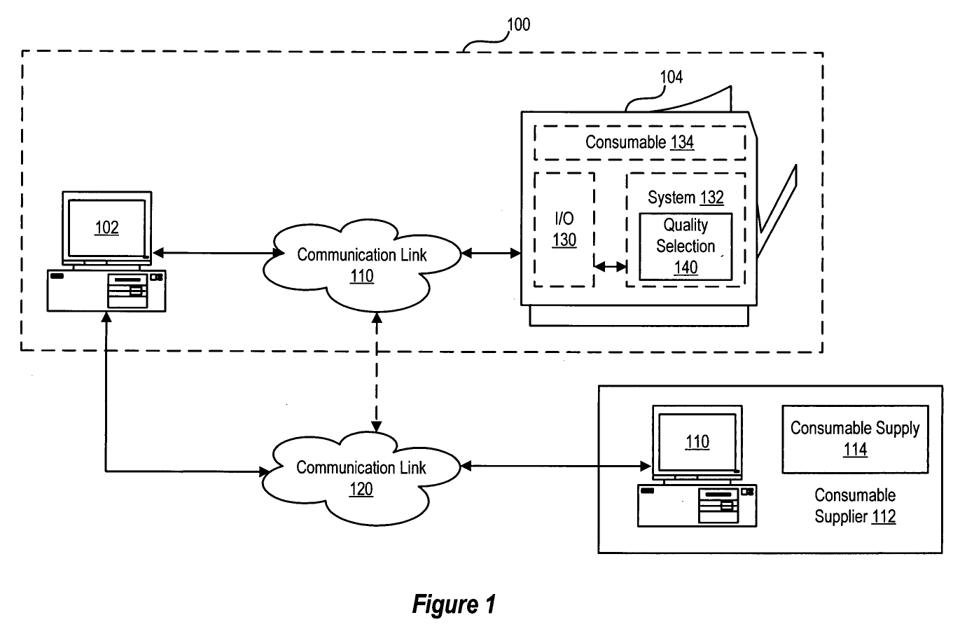

Referring to FIG. 1, a block diagram of an environment in which a printer is used is shown. The environment includes a computer system 102 and a printer 104, coupled via a communication link 110.

The computer system 102 is also connected to another computer system (e.g., a vendor computer system) 110 via a second communication link 120. The second communication link 120 may be a telephone system or some other type of network, such as the Internet. In one embodiment, computer system 110 is owned and operated by a printer consumable supplier 112. In this example, the printer consumable supplier 112 provides printer consumables for use with the printer 104 from a supply 114 of printer consumables. The printer 104 may be directly coupled to the second communication link 120, in which case communication may occur between the printer and anything coupled to the second communication link 120.

The printer 104 includes an input output (I/O) port 130, a control system 132 and at least one printer consumable 134. The I/O port 130 facilitates communications between the printer 104 and other devices connected to the communications link 110. The control system 132 provides the printer 104 with certain control functionality. The control system 132 includes a processor and memory coupled to the processor. The control system 132 includes a print quality selection module 140. The print quality selection module 140 may be stored on either the memory of the printer or within the memory of the computer system 102

The printer consumable 134 represents any component in the printer 104 that is subject to depletion through use of the printer 104. For example, the printer consumable 134 may be a toner cartridge or an inkjet cartridge, etc. The printer consumable supplier maintains a supply 114 of replacement printer consumables 134.

The computer system 102 generates a document in an electronic form and transmits the document (in the form of a print job) to the printer 104. The printer 104 receives the print job via the I/O port 130 and prints the document. Each time the printer 104 prints a document, the printer 104 transmits a pre-defined message to the computer 102.

It may be determined that the consumable 134 should be replaced when certain criteria are met. For example, it is assumed that the consumable 134 should be replaced each time the printer 104 prints “n” pages. When this event occurs, the control system 132 sets a consumable replacement indicator.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In accordance with the present invention, a printer is provided with a print quality selection module which enables a user to select multiple quality settings for each printout. The user selects the quality settings via a print driver graphical user interface (GUI). Thus, within a single print job, a user can select a higher quality setting for the graphics and a lower quality setting for the text or vice versa. The printer quality selection module thus provides a user with greater control over the amount of ink used on mixed printouts.

The print quality selection module identifies the content of a print job, discriminating objects such as text and graphics, and then rasterizes the print job according to the discrete settings provided by the user to the print quality selection module. In one embodiment, the print quality module is included within a printer driver.

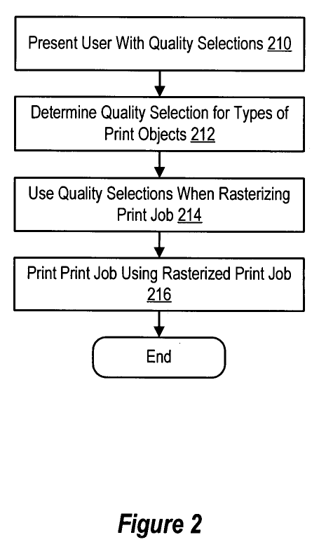

Referring to FIG. 2, a flow chart showing the operation of the print quality selection module 140 is shown. More specifically, the print quality selection module 140 starts operation by presenting a user with quality selection options for various types of print objects at step 210. For example, a user might select a draft quality for text objects while selecting a better quality for graphics objects.

The operation continues with the print quality selection module 140 determines the selections for the various types of print objects at step 212. Next the printer device driver rasterizes the print job based upon the selections at step 214. Next, the printer 104 prints the print job using the rasterized print job.

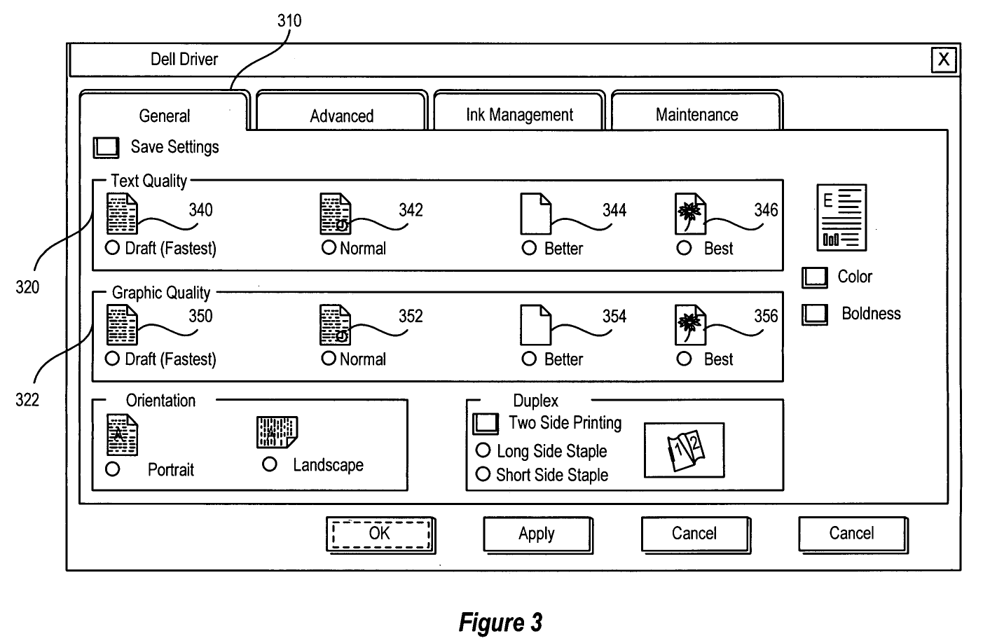

Referring to FIG. 3, an example of a print quality selection module graphical user interface 310 is shown. The print quality selection module graphical user interface 310 presents a user with a plurality of quality selections for various types of print objects. For example, the presentation includes a text object selection portion 320 and a graphics object selection portion 322.

The text object selection portion 320 includes a draft quality selection 340, a normal quality selection 342, a better quality selection 344 and a best quality selection 346. Each of these quality selections correspond to a particular print job quality. So for example, a draft quality selection might produce text having a print quality of a certain number of dots per inch while a normal quality selection might produce text objects having a print quality of more dots per inch. Other variables relating to print quality include DPI, render resolutions, drop size, half toning and other known image quality variable.

The graphics object selection portion 320 includes a draft quality selection 350, a normal quality selection 352, a better quality selection 354 and a best quality selection 356. Each of these quality selections correspond to a particular print job quality. So for example, a draft quality selection might produce graphics having a print quality of a certain number of dots per inch while a normal quality selection might produce graphics objects having a print quality of more dots per inch.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while a particular printer architecture is set forth, it will be appreciated that variations within the printer architecture are within the scope of the present invention.

Also for example, the print selection module might provide print quality selection for other types of objects, such as photograph objects.

Also for example, the print selection module 140 might include an option to select whether certain types of print objects are printed in color while other types of print objects are printed in grayscale.

Also for example, the above-discussed embodiments include modules and units that perform certain tasks. The modules and units discussed herein may include hardware modules or software modules. The hardware modules may be implemented within custom circuitry or via some form of programmable logic device. The software modules may include script, batch, or other executable files. The modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules and units is for illustrative purposes. Alternative embodiments may merge the functionality of multiple modules or units into a single module or unit or may impose an alternate decomposition of functionality of modules or units. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for controlling quality of a print job comprising:
selecting a first print quality for a first type of print object;
selecting a second print quality for a second type of print object;
printing a print job such that the first type of print object is printed having the first print quality and the second type of print object is printed having the second print quality.

2. The method of claim 1 further comprising:
providing a print quality selection graphical user interface; and wherein
the first print quality and second print quality are selected via the graphical user interface.

3. The method of claim 1 further comprising:
providing a print quality selection module; and wherein
the first print quality and second print quality are selected using the print quality selection module.

4. The method of claim 1 wherein:
the first type of print object include graphics objects.

5. The method of claim 1 wherein:
the second type of print object include text objects.

6. An apparatus for controlling quality of a print job comprising:
means for selecting a first print quality for a first type of print object;
means for selecting a second print quality for a second type of print object;
means for printing a print job such that the first type of print object is printed having the first print quality and the second type of print object is printed having the second print quality.

7. The apparatus of claim 6 further comprising:
means for providing a print quality selection graphical user interface; and wherein
the first print quality and second print quality are selected via the graphical user interface.

8. The apparatus of claim 6 further comprising:
providing a print quality selection module; and wherein
the first print quality and second print quality are selected using the print quality selection module.

9. The apparatus of claim 6 wherein:
the first type of print object include graphics objects.

10. The apparatus of claim 6 wherein:
the second type of print object include text objects.

11. An information handling system comprising:
an input output port;
a control system coupled to the input output port, the control system including
a quality selection module, the quality selection module controlling quality of a job, the quality selection module including
a first selecting module, the selecting module selecting a first print quality for a first type of object;
a second selection module, the second selecting module selecting a second print quality for a second type of object;
a presentation module, the presentation module presenting the job such that the first type of object is presented having the first presentation quality and the second type of object is presented having the second presentation quality.

12. The information handling system of claim 11 further comprising:
a user interface module, the user interface module providing a quality selection graphical user interface; and wherein
the first quality and second quality are selected via the graphical user interface.

13. The information handling system of claim 11 wherein:
the first type of object includes graphics objects.

14. The information handling system of claim 11 wherein:
the second type of object include text objects.

15. The information handling system of claim 11 wherein:
the information handling system includes a printer.

16. The information handling system of claim 11 wherein:
the information handling system includes a multifunction device, one function of the multifunction device being a print function.
